(19) United States
(12) Patent Application Publication
(10) Pub. No.: US 2026/0176054 A1
(43) Pub. Date: Jun. 25, 2026

(54) CAPSULE FOR USE IN PREPARING A BEVERAGE

(71) Applicant: VARDEN PROCESS PTY LTD, Braeside, Victoria (AU)

(72) Inventors: Mark APPLEFORD, Braeside, Victoria (AU); Stuart GORDON, Braeside, Victoria (AU); Connor LOWNDES, Braeside, Victoria (AU); Liam METHVEN, Braeside, Victoria (AU)

(21) Appl. No.: 19/119,955

(22) PCT Filed: Oct. 10, 2023
(86) PCT No.: PCT/AU2023/050997

§ 371 Date: Apr. 10, 2025

(30) Foreign Application Priority Data
Oct. 10, 2022 (AU) 2022902969
Aug. 21, 2023 (AU) 2023902652

(51) Int. Cl. B65D 85/804

(52) U.S. Cl. CPC B65D 85/8043

(57) ABSTRACT

A capsule for use in preparing a beverage in a beverage preparation device that has a brewing chamber. The capsule has a body having a cup shape that defines an internal cavity within which to contain a beverage ingredient, and a flange that extends radially outwardly from a mouth of the body. The flange includes a chamber engagement portion that, during preparation of a beverage, is to be in engagement with components of the beverage preparation device that define the brewing chamber. The body and the flange are formed of compressed pulp fibre material. The chamber engagement portion of the flange has a density of the pulp fibre material that is less than the maximum density of the pulp fibre material in the body.

### FIELD OF THE INVENTION

The present invention relates to a capsule for use in preparing a beverage. The present invention also relates to a beverage capsule that incorporates the capsule, and to a beverage preparation system.

### BACKGROUND

It is known to prepare a beverage from a single-use beverage capsule using a beverage preparation system that is designed to co-operate with the beverage capsule in the beverage preparation process. Beverage preparation systems of this type are desirable for the consistency of the beverage that is brewed by the consumer. To this end, the provider of the single-use beverage capsule has control of some flavour related characteristics of the beverage ingredient that is contained in the beverage capsule, these characteristics including the flavour profile of the beverage, which is influenced by the ingredient(s). In addition, the provider of the beverage preparation device that receives the beverage capsules has control of some variables of the preparation device performance, these variables including the water temperature, pressure, and flow rate, and the “shot” volume. These variables can influence the flavour profile of the beverage.

One known brewing system requires the use of a capsule having a cup-shaped body extending from a flange. The body defines an internal cavity within which to contain a dose of the beverage ingredient. A lid is secured to the flange, and closes and seals the internal cavity of the beverage capsule. To prepare the beverage, the beverage capsule is loaded into the beverage preparation device. The device has two components that are movable relative to one another to form a brewing chamber into which the beverage capsule locates. As the two components are moved relative to one another, and close around the beverage capsule, the capsule is pierced at the base of the body (that is, the opposite part of the body to the flange/lid). Pressurised hot water is injected into the brewing chamber, and enters the interior of the beverage capsule via the piercings. A beverage extract is extracted by infusion of the hot water with the beverage ingredient(s). With sufficiently high internal pressure within the brewing chamber and beverage capsule (generated by injection of the pressurised hot water), the lid is ruptured by pressure against an orifice plate. The beverage extract is then discharged through the orifice plate and via a discharge duct. Once brewing is complete, the brewing chamber is opened to release the spent beverage capsule, which is then discarded.

In the above described beverage preparation device, part of the beverage capsule is an integral element in the formation of the pressurized brewing chamber. To this end, the flange of the beverage capsule becomes a sealing element between the two components as the brewing chamber is formed. It is known to include elastomeric materials within the flange of the capsule to achieve good sealing performance of the brewing chamber during the beverage preparation process. In this way, the beverage extract is prevented from leaking between the two components that form the brewing chamber.

In this specification and the claims that follow, the term “beverage extract” is a term that describes a mixture of a liquid ingredient (typically water) and a beverage ingredient (or beverage ingredients), the mixture being predominantly in liquid form. The mixture is formed by the infusion process, whereby chemical constituents of the beverage ingredient(s) are dissolved, and hence are extracted. Beverage extracts may include particulate matter (in other words, sedimentary material) from the beverage ingredient(s) that are entrained with the mixture.

Beverage capsules for the above described brewing system may store the beverage ingredients for an extended period; in some cases, in the order of 12 months from filling of the beverage capsule by the provider, to preparation of the beverage by the consumer. It is known that beverage ingredients degrade with exposure to oxygen, and water vapour. For this reason, it is desirable for the beverage capsule to provide a high barrier to oxygen transmission, and water vapour transmission.

Many beverage capsules for the above described brewing system are made of aluminium, which has good barrier properties. The spent capsule is then an item consisting of biodegradable/compostable matter (the beverage ingredients), and non-compostable materials (the aluminium, and elastomeric materials, if included). While aluminium is recyclable, the presence of the biodegradable/compostable matter prevents effective recycling. The presence of the elastomeric material exacerbates this problem.

To provide a more sustainable alternative, it is known to form beverage capsules from bioplastics (in other words, polymers that are derived from biological materials). Bioplastics are known to have particularly poor oxygen and water vapour transmission performance characteristics. Hence, the beverage ingredients contained in bioplastic beverage capsules are often compromised by exposure to oxygen and water vapour from the atmosphere. Alternatively, secondary packaging is used to reduce this exposure.

It is also known to form beverage capsules that include pulp fibre material, which can be home/industrially compostable. The pulp fibre material is moulded to form the cup-shaped body and flange. Traditionally moulded pulp fibre materials have particularly poor oxygen and water vapour transmission performance characteristics. To improve the performance of moulded pulp fibre beverage capsules, it is known to incorporate a liner material that provides the barrier. As such, the predominant function of the moulded pulp fibre is to provide the structural form of the beverage capsule.

In the specification and claims that follow, the term “capsule” is to be understood to generally refer to the article that has the cup-shaped body and flange. The term “beverage capsule” is to be understood to refer to that article together with a lid secured to the flange.

There is a need to address the above, and/or at least provide a useful alternative.

### SUMMARY

There is provided a capsule for use in preparing a beverage in a beverage preparation device that has a brewing chamber, the capsule comprising:
a body having a cup shape that defines an internal cavity within which to contain a beverage ingredient; and
a flange that extends radially outwardly from a mouth of the body, the flange including a chamber engagement portion that, during preparation of a beverage, is to be in engagement with components of the beverage preparation device that define the brewing chamber,
wherein the body and the flange are formed of compressed pulp fibre material, and
wherein at least the chamber engagement portion of the flange has a density of the pulp fibre material that is less than the maximum density of the pulp fibre material in the body.

In at least some embodiments, the flange has a radially outer portion that surrounds the chamber engagement portion, wherein the density of the pulp fibre material within the chamber engagement portion is less than the maximum density of the pulp fibre material in the radially outer portion.

There is provided a capsule for use in preparing a beverage in a beverage preparation device that has a brewing chamber, the capsule comprising:
a body having a cup shape that defines an internal cavity within which to contain a beverage ingredient; and
a flange that extends radially outwardly from a mouth of the body, the flange including:
a chamber engagement portion that, during preparation of a beverage, is to be in engagement with components of the beverage preparation device that define the brewing chamber, and
a radially outer portion that surrounds the chamber engagement portion,
wherein the body and the flange are formed of compressed pulp fibre material, and
wherein the minimum density of the pulp fibre material within the chamber engagement portion is less than the maximum density of the pulp fibre material in the radially outer portion.

The flange can include a radially innermost portion that spaces the chamber engagement portion from the body, wherein the innermost portion has a density of pulp fibre material that is greater than the minimum density of the pulp fibre material in the chamber engagement portion.

There is provided a capsule for use in preparing a beverage in a beverage preparation device that has a brewing chamber, the capsule comprising:
a body having a cup shape that defines an internal cavity within which to contain a beverage ingredient; and
a flange that extends radially outwardly from a mouth of the body, the flange including:
a chamber engagement portion that, during preparation of a beverage, is to be in engagement with components of the beverage preparation device that define the brewing chamber, and
a radially innermost portion that spaces the chamber engagement portion from the body,
wherein the body and the flange are formed of compressed pulp fibre material, and
wherein the innermost portion has a maximum density of pulp fibre material that is greater than the minimum density of the pulp fibre material in the chamber engagement portion.

In at least some embodiments, the pulp fibre density within the flange is approximately inversely proportional to the material thickness.

Preferably, the chamber engagement portion is an annular part of the flange.

In some embodiments, the pulp fibre material within the radially innermost portion of the flange has a density that:
is greater than that of the pulp fibre material within the chamber engagement portion, and
is less than that of the pulp fibre material within the annular side wall.

Alternatively or additionally, the density of the pulp fibre material within the radially innermost portion of the flange is approximately equal to that of the pulp fibre material within the annular side wall.

Preferably, the flange has a first major surface that faces away from the body and provides a contact surface against which a lid is to be adhered, wherein the material thickness of the chamber engagement portion is greater than the material thickness of the radially outer portion. The material thickness being measured in a direction substantially perpendicular to the planar portion of the major surface.

Alternatively or additionally, the maximum material thickness of the chamber engagement portion is greater than the material thickness of the radially outer portion.

In certain embodiments in which the flange includes the radially innermost portion, the maximum material thickness of the chamber engagement portion is greater than the maximum material thickness of the radially innermost portion.

In some examples, the first major surface is substantially planar. In some other examples, the first major surface is concave and conical. Preferably, the first major surface has a cone angle of no more than 2°.

In certain embodiments, the chamber engagement portion is immediately adjacent the body.

The chamber engagement portion can be arranged with:
a first part, in which the density of the pulp fibre material transitions from a first density to a second density, and
a second part, in which the density of the pulp fibre material is substantially constant and equal to the second density,
wherein the first density is greater than the second density.

Preferably, the first part of the chamber engagement portion is between the radially outer portion of the flange, and the second part of the chamber engagement portion.

The chamber engagement portion can be further arranged with a third part in which the density of the pulp fibre material increases in a radially inward direction.

Preferably, the third part of the chamber engagement portion is between the second part and the body.

Alternatively or additionally, the flange has a second major surface that faces in the direction of the body, wherein the part of the second major surface that is within the chamber engagement portion is more rough compared to:
the external surface of the body, and/or
the part of the second major surface that is within the radially outer portion.

In some examples, the ratio of the arithmetic mean height roughness between the part of the second major surface that is within the chamber engagement portion and the part of the second major surface that is within the radially outer portion is at least 1.5:1. In certain instances, the ratio of the arithmetic mean height roughness between the part of the second major surface that is within the chamber engagement portion and the part of the second major surface that is within the radially outer portion is at least 2.5:1. In some cases, the ratio of the arithmetic mean height roughness between the part of the second major surface that is within the chamber engagement portion and the part of the second major surface that is within the radially outer portion is approximately 3.5:1.

In some examples, the ratio of the maximum height roughness between the part of the second major surface that is within the chamber engagement portion and the part of the second major surface that is within the radially outer portion is at least 1.5:1. In certain instances, the ratio of the maximum height roughness between the part of the second major surface that is within the chamber engagement portion and the part of the second major surface that is within the radially outer portion is at least 2.5:1. In some cases, the ratio of the maximum height roughness between the part of the second major surface that is within the chamber engagement portion and the part of the second major surface that is within the radially outer portion is approximately 3.5:1.

There is also provided a capsule for use in preparing a beverage in a beverage preparation device that has a brewing chamber, the capsule comprising:
a body having a cup shape that defines an internal cavity within which to contain a beverage ingredient; and
a flange that extends radially outwardly from a mouth of the body, the flange including:
a chamber engagement portion that, during preparation of a beverage, is to be in engagement with components of the beverage preparation device that define the brewing chamber,
a radially outer portion that surrounds the chamber engagement portion, and defines a radially outer peripheral edge of the flange, and
a first major surface that faces away from the body and provides a contact surface against which a lid is to be adhered, a portion of the first major surface being substantially planar,
wherein the body and the flange are formed of compressed pulp fibre material, and
wherein the material thickness of the chamber engagement portion is greater than the material thickness of the radially outer portion.

The capsule can be configured for use with a beverage preparation device that includes a capsule holder with an enclosure to receive the body of the capsule, and one or more mating components that include an orifice plate that faces towards the enclosure, at least one of the capsule holder and orifice plate being movable relative to the other between an open configuration and a closed configuration, whereby:
in the open configuration the capsule can be moved into and out of the enclosure, and
in the closed configuration the mouth of the body is adjacent the orifice plate, and a brewing chamber is defined in the enclosure and between the capsule holder and the mating components, and wherein
the flange of the capsule is arranged such that at least part of chamber engagement portion has a material thickness sufficient to be compressed and clamped between the capsule holder and the mating components in the closed position, such that the flange of the capsule forms a sealing element for the brewing chamber.

Preferably, the chamber engagement portion forms the sealing element for the brewing chamber.

The material thickness being measured in a direction substantially perpendicular to the planar portion of the major surface.

In certain embodiments, the chamber engagement portion is immediately adjacent the body. In some alternative embodiments, the chamber engagement portion is spaced from the body by an innermost portion of the flange.

The chamber engagement portion can be arranged with:
a first part, in which the material thickness of the pulp fibre material transitions from a first material thickness to a second material thickness, and
a second part, in which the material thickness of the pulp fibre material transitions from the second material thickness to a third material thickness,
wherein the first material thickness is less than the second material thickness, and the second material thickness is less than the third material thickness.

Preferably, the first part of the chamber engagement portion is between the radially outer portion of the flange, and the second part of the chamber engagement portion.

The chamber engagement portion can be further arranged with a third part in which the material thickness of the pulp fibre material is substantially constant.

Preferably, the third part of the chamber engagement portion is between the second part and the body.

There is also provided a capsule for use in preparing a beverage in a beverage preparation device that has a brewing chamber, the capsule comprising:
a body having a cup shape that defines an internal cavity within which to contain a beverage ingredient; and
a flange that extends radially outwardly from a mouth of the body, the flange including:
a chamber engagement portion that, during preparation of a beverage, is to be in engagement with components of the beverage preparation device that define the brewing chamber,
a radially outer portion that surrounds the chamber engagement portion, and defines a radially outer peripheral edge of the flange,
a first major surface that faces away from the body and provides a contact surface against which a lid is to be adhered, and
a second major surface that faces in the direction of the body,
wherein the part of the second major surface that is within the chamber engagement portion is more rough compared to:
the external surface of the body, and/or
the part of the second major surface that is within the radially outer portion.

In at least some embodiments, the body and the flange of the capsule are formed contiguously in a pulp moulding process.

In at least some embodiments, the greater roughness of the part of the second major surface that is within the chamber engagement portion is a result of that part of the second major surface being unconstrained during a pulp fibre pressing stage in the pulp moulding process by which the capsule is formed.

In some embodiments, one or more coating materials can be applied to the body and/or the flange to enhance the capacity of the capsule to act as a barrier to one or more atmospheric gases.

There is also provided a beverage capsule for use with a beverage preparation device to prepare a beverage, the beverage capsule comprising:
a capsule as previously described;
a lid that is adhered to the flange of the capsule to close and seal the internal cavity; and
a dose of beverage ingredients contained within the internal cavity.

There is also provided a beverage preparation system that includes a beverage preparation device, and a beverage capsule as previously described.

There is also provided a beverage preparation system that includes a beverage preparation device that is configured to cooperate with a beverage capsule as previously described, the beverage preparation device comprising:
a capsule holder with an enclosure to receive the body of the capsule;
one or more mating components that include an orifice plate that faces towards the enclosure, in use of the system, beverage extract is to pass through the orifice plate;
at least one of the capsule holder and orifice plate being movable relative to the other between an open configuration and a closed configuration, whereby:
in the open configuration the capsule can be moved into and out of the enclosure, and
in the closed configuration the mouth of the body is adjacent the orifice plate with a predefined separation distance between the capsule holder and the mating components, the predefined separation distance being in a direction substantially perpendicular to the orifice plate, and a brewing chamber is defined in the enclosure and between the capsule holder and the mating components; and
a liquid delivery subsystem that is configured to supply pressurised liquid to a liquid inlet to the brewing chamber,
wherein at least one of the beverage preparation device and the beverage capsule is configured with the chamber engagement portion having a material thickness, such that at least part of the flange of the capsule is compressed and clamped between the capsule holder and the mating components in the closed position, such that the beverage capsule forms a sealing element for the brewing chamber.

Preferably, the chamber engagement portion forms the sealing element for the brewing chamber.

### BRIEF DESCRIPTION OF THE DRAWINGS

In order that the invention may be more easily understood, embodiments will now be described, by way of example only, with reference to the accompanying drawings, in which:

FIG. 1: is a perspective view of a capsule according to an embodiment of the invention;

FIG. 2: is a side elevation view of the capsule of FIG. 1;

FIG. 3: is an enlarged view of Region A in FIG. 2;

FIG. 4: is a cross section view of the capsule, as viewed in direction IV-IV of FIG. 2;

FIG. 5: is an enlarged view of Region B in FIG. 4;

FIG. 6: is a schematic view of a beverage capsule that includes the capsule of FIG. 1, together with component parts of a beverage preparation device according to another embodiment;

FIG. 7: is a schematic view of the beverage capsule and component parts of the beverage preparation device of FIG. 6, with the component parts in a closed configuration;

FIG. 8: is an enlarged view of Region D of FIG. 7;

FIG. 9: is an equivalent view of FIG. 8, with component parts of an alternative beverage preparation device;

FIG. 10: is a cross section view of a capsule according to another embodiment of the invention;

FIG. 11: is an enlarged view of Region E in FIG. 10; and

FIG. 12: is a cross section view of a beverage capsule incorporating the capsule body of FIG. 10;

FIG. 13: is an enlarged view of Region F in FIG. 12; and

FIG. 14: is an enlarged schematic view of the beverage capsule of FIG. 12, together with component parts of the beverage preparation device, with the component parts in a closed configuration.

### DETAILED DESCRIPTION

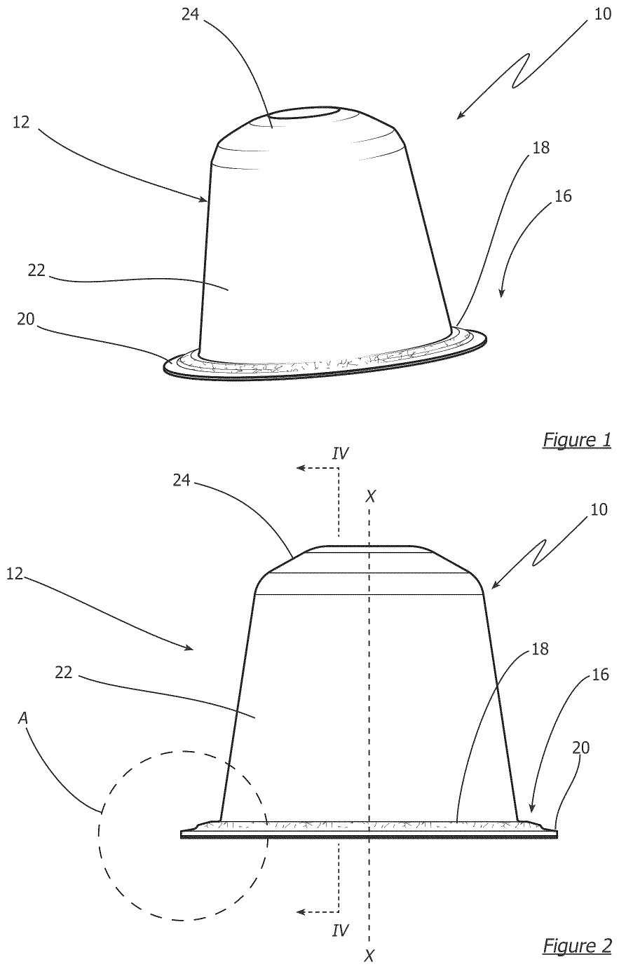

FIGS. 1 to 5 show a capsule 10 for use in preparing a beverage in a beverage preparation device that has a brewing chamber. The preparation of a beverage, as it pertains to a beverage capsule that includes capsule 10 is discussed in further detail in reference to FIGS. 6 to 9.

The capsule 10 has a body 12 with a cup shape that defines an internal cavity 14. When the capsule 10 is assembled with a lid to form the beverage capsule a beverage ingredient is to be contained within the internal cavity 14. A flange 16 extends radially outwardly from a mouth of the body 12.

The flange 16 includes a chamber engagement portion 18 that, during preparation of a beverage, is to be in engagement with components of the beverage preparation device that define the brewing chamber. This engagement is also described in further detail below in reference to FIGS. 6 to 9. In this particular example, the chamber engagement portion 18 is an annular part of the flange 16. The flange 16 also includes a radially outer portion 20 that surrounds the chamber engagement portion 18.

The body 12 and the flange 16 are formed of a substantially inelastically compressible material. In this particular embodiment, body 12 and the flange 16 are formed of compressed pulp fibre material. By way of example only, the body 12 and flange 16 can be formed using pulp fibre thermoforming equipment in which pulp fibres are shaped and compressed to form the body and flange.

If desired and/or necessary, coating materials can be applied to the body and/or the flange to enhance the capacity of the capsule to act as a barrier to atmospheric gas(es).

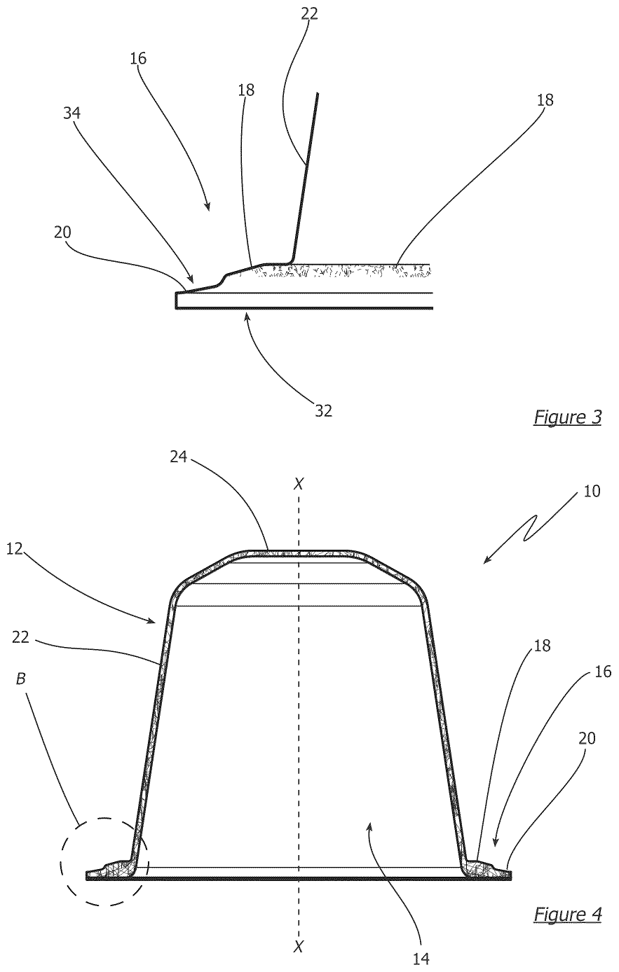

In this example, the capsule 10 is rotationally symmetrical about a longitudinal axis X, as indicated in FIGS. 2 and 4. The body 12 of the capsule 10 includes an annular side wall 22, and a base 24 (which may also be known as a “crown”). At least the external shape of the body 12 is configured to complement the shape of components of the beverage preparation device(s) with which the beverage capsule is to cooperate in preparing the beverage.

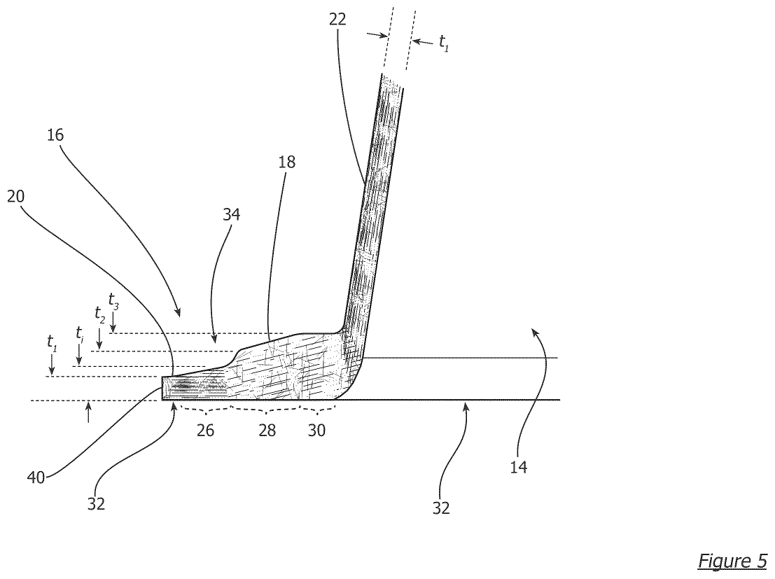

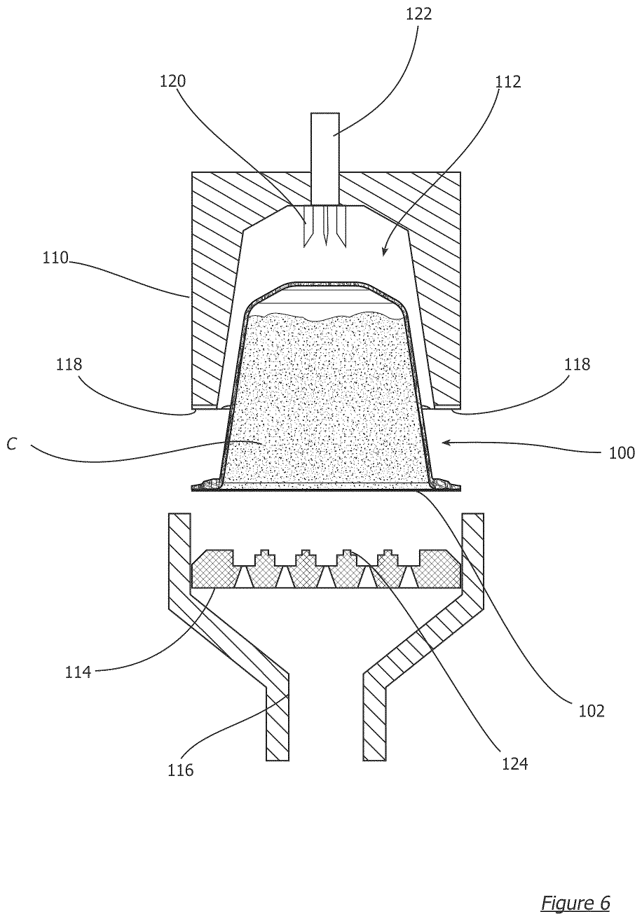

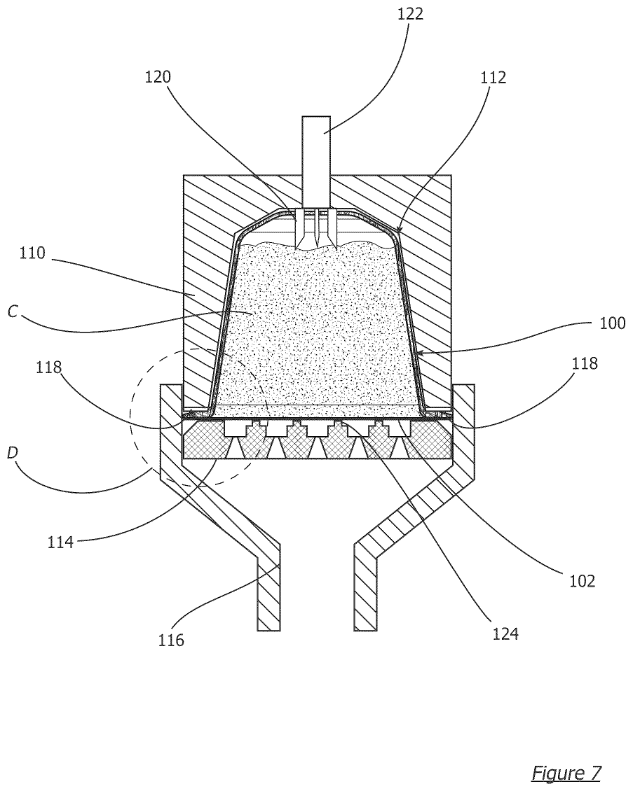

As indicated in FIG. 5, the chamber engagement portion 18 of the flange 16 has a density of the pulp fibre material that is less than the maximum density of the pulp fibre material in the body 12. In addition, the density of the pulp fibre material within the chamber engagement portion 18 is less than the maximum density of the pulp fibre material in the radially outer portion 20.

Further, in this particular example, the chamber engagement portion 18 is arranged to have a first part 26, a second part 28, and a third part 30. Within the first part 26, the material thickness of the pulp fibre material transitions in a radial direction from a first material thickness t₁ to a second material thickness t₂. Within second part 28, in which the material thickness of the pulp fibre material transitions in a radial direction from the second material thickness t₂ to a third material thickness t₃. As shown in FIG. 5, the first material thickness t₁ is less than the second material thickness t₂, and the second material thickness t₂ is less than the third material thickness t₃.

Within the third part 30 of the chamber engagement portion 18, the material thickness of the pulp fibre material is substantially constant.

The above described transitions between material thicknesses do not need to be linear with respect to radial distance from the longitudinal axis X. For example, as shown in FIG. 5, within the first part 26 the material thickness of the flange 16 is conically tapered at a first pitch angle between the first material thickness t₁ and an intermediate material thickness t₁. Between the intermediate material thickness t₁ and the second material thickness t₂ the flange 16 is conically tapered at a second pitch angle. The second pitch angle being larger than the first pitch angle.

The first part 26 of the chamber engagement portion 18 is between the radially outer portion 20 and the second part 28 of the chamber engagement portion 18. Further, the third part 30 of the chamber engagement portion 18 is between the second part 28 and the body 12.

In this particular example, the material thickness t₁ of the radially outer portion 20 is approximately equal to the material thickness of the annular side wall 22 of the body 12 in the region adjacent the mouth of the body 12.

With respect to the density of the pulp fibre in the chamber engagement portion 18:
in the first part 26, the density of the pulp fibre material transitions in a radial direction from a first density to a second density,
in the second part 28, the density of the pulp fibre material is substantially constant and equal to the second density, and
in the third part 30, the density of the pulp fibre material increases in a radially inward direction (that is, in the direction towards the longitudinal axis X).

The pulp fibre density within the flange is approximately inversely proportional to the material thickness. Hence, the first density is greater than the second density. However, the density of the pulp fibre is also determined by the amount of pulp fibre slurry that is accumulated in the initial stages of forming the capsule 10, and factors relating to the compression of that accumulated pulp fibre during subsequent stages of forming the capsule 10. In this regard, reference may be made to the processes and forming equipment that are described and illustrated in the Australian Patent Application No. 2023901521 (filed in the name of the Applicant on 17 May 2023), the disclosure of which is incorporated herein by reference.

The chamber engagement portion 18 of the flange 16 can be formed using the processes and forming equipment that are described and illustrated in Australian Patent Application No. 2022902962 (filed in the name of the Applicant on 10 Oct. 2022), the disclosure of which is incorporated herein by reference.

In the embodiment of FIGS. 1 to 5, the radially outer portion 20 defines an outer peripheral edge 40 of the flange 16.

The flange 16 has a first major surface 32 that faces away from the body 12, and a second major surface 34 that faces in the direction of the body 12. In other words, the first and second major surfaces 32, 34 are on opposing faces of the flange 16.

The first major surface 32 provides a contact surface against which a lid is to be adhered. In this example, at least a portion of the first major surface 32 is substantially planar. As indicated in FIG. 5, material thicknesses of the flange 16 are in a direction substantially perpendicular to the planar portion of the major surface 32.

The part of the second major surface 34 that is within the chamber engagement portion 18 is more rough compared to both the external surface of the body, and the part of the second major surface 34 that is within the radially outer portion 20. This relative greater roughness is indicated in FIGS. 1 to 3. This greater roughness in this part of the surface of the capsule 10 is a result of that part of the second major surface 34 being unconstrained during a pulp fibre pressing stage in the formation of the capsule 10.

In this example, the capsule 10 is configured with the chamber engagement portion 18 to transition into the annular side wall 22 of the body 12. In some alternatives, the flange 16 can be configured with a portion of higher density and lower material thickness (compared with the chamber engagement portion 18) to be disposed between the chamber engagement portion 18 and the body 12.

Where the capsule 10 is formed of pulp fibre material, the body 12 and the flange 16 are formed contiguously in a pulp moulding process. In other words, the body 12 and flange 16 are formed as a unitary item.

FIGS. 6 to 8 show a beverage capsule 100 that includes the capsule 10 of FIG. 1. The beverage capsule 100 also includes a lid 102 that is adhered to the flange 16 of the capsule 10. A dose of a beverage ingredient Cis contained within the internal cavity of the beverage capsule 100.

FIGS. 6 to 8 also show component parts of a beverage preparation device. These component parts are shown schematically and for illustrative purposes only. The illustrated component parts include a capsule holder 110 with an enclosure 112 that is to receive the body 12 of the beverage capsule 100, and mating components that include an orifice plate 114 and an outlet duct 116.

The capsule holder 110 and mating components are movable relative to one another between an open configuration, and a closed configuration. In the open configuration, the beverage capsule 100 is able to manoeuvred into and out of the enclosure 112. In an actual beverage preparation device, additional components may be incorporated to at least semi-automate (or fully automate) the manoeuvring of the beverage capsule 100 from an insertion location of the device, and to a discharge location of the device.

A leading face of the capsule holder 110 has an engagement face 118.

In the closed configuration (schematically illustrated in FIG. 7), the external face of the lid 102 is positioned against the orifice plate 114, and the engagement face 118 bears against the second major surface 34 of the capsule 10. In this closed configuration, a “brewing chamber” is defined internally of the enclosure 112, and between the capsule holder 110 and the orifice plate 114.

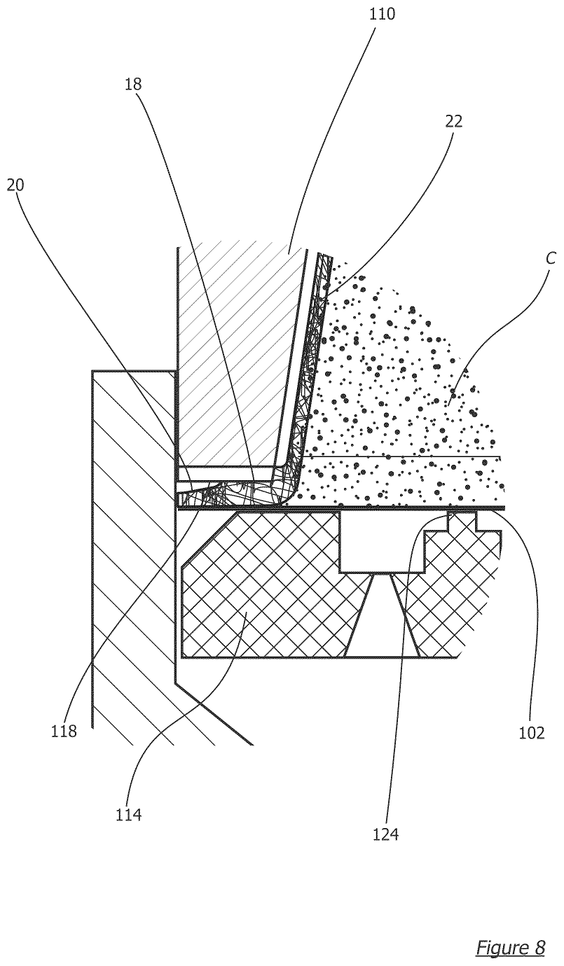

As will be apparent from FIG. 8, when the capsule holder 110 and mating components are in the closed configuration, the beverage capsule 100 forms a sealing element for the brewing chamber.

The beverage preparation device also includes capsule piercing blades 120, and a water inlet 122 to the enclosure 112. The water inlet 122 is interconnected with a liquid delivery subsystem (not shown) that is configured to supply liquid, such as water, under pressure up to 20 bar (and typically up to 18 bar). It will be appreciated that the form and configuration of the liquid delivery subsystem and the water inlet shown in the drawings is shown and described for illustrative purposes, and is not intended to accurately reflect the specific arrangement of known beverage preparation devices.

The orifice plate 114 includes formations 124 that are shaped so that pressure of the lid 102 against the orifice plate 114 will cause the lid 102 to rupture. Orifices in the orifice plate 114 permit liquid to pass through the plate for collection and discharge through the outlet duct 116.

To prepare the beverage, the beverage capsule 100 is loaded into the device, and the device is operated to adopt the closed configuration. With this movement, the flange 16 of the beverage capsule 100 is clamped between the capsule holder 110 and the orifice plate 114. Simultaneously, the capsule piercing blades 120 pierce the base 24 of the beverage capsule 100, as illustrated in FIG. 7.

The liquid delivery subsystem is then operated to supply liquid into the brewing chamber via the water inlet 122. The liquid fills the brewing chamber, and in doing so enters the internal cavity 14 of the beverage capsule 100 via holes introduced in the beverage capsule 100 by the capsule piercing blades 120. Fluid pressure within the capsule 10 presses the lid 102 against the orifice plate 114; with sufficient pressure, causing the lid 102 to rupture on the formations 124. As water contacts the beverage ingredient C, the water is infused with the ingredient. After rupture of the lid 102, continued flow of water into the beverage capsule 100 causes the beverage extract to flow through the orifice plate 114 and outlet duct 116.

The above described clamping of the flange 16 of the beverage capsule 100 between the capsule holder 110 and the orifice plate 114 is a significant aspect to reliable beverage preparation; this is the case for many, if not all, beverage capsules and brewing devices of this general type. In particular, it is necessary for the lid 102 of the beverage capsule 100 to be appropriately positioned with respect to the orifice plate 114 for the formations 124 to reliably rupture the lid 102 at an ideal internal pressure within the internal cavity 14. To this end, it is known that the extent of initial infusion of water with the beverage ingredient C contributes to the flavour profile of the prepared beverage. In some prior art brewing systems, this appropriate positioning is achieved through incorporation of the flange as a sealing element to the brewing chamber.

The beverage preparation device is configured to have a predefined separation distance between the capsule holder 110 and the mating components, when in the closed configuration. In this regard, the predefined separation distance is in a direction substantially perpendicular to the orifice plate 114. To this end, the predefined separation distance in this example is the minimum distance between the engagement face 118 and the orifice plate 114. In practice, the presence of a beverage capsule between the capsule holder 110 and the orifice plate 114 can result in the actual separation being slightly greater than the predefined separation distance.

It will be appreciated that the material thickness and the capacity of the flange to be compressed are important aspects to the operation of the beverage preparation device. The capacity of the flange to be compressed is at least partly dependent on the density of the material(s) in the flange. If the flange material is of insufficient thickness, the seal created by the flange will be poor, which would lead to liquid leakage past the flange, and between the capsule holder 110 and the orifice plate 114. Similarly, if fluid pressure from within the brewing chamber has the capacity to deform the capsule (for example, due to material characteristics the flange of the capsule), a similar liquid leakage is likely to occur.

Conversely, if the flange material is too thick, and is insufficiently compressible having regard to the flange thickness, then the clamping force required to bring the device into the closed configuration will be too high. In this scenario, it will either not be possible to bring the beverage preparation device into its closed configuration with the capsule in the brewing chamber, or doing so would place excessive loads on the beverage preparation device components with the risk of damage to the device.

The above described observations and scenarios relating to clamping of the flange of a beverage capsule between the capsule holder 110 and the mating components, when in the closed configuration are exacerbated by various factors. These include the large “envelope” of relative positions that a beverage capsule can occupy with respect to the capsule holder 110 and mating components as the beverage preparation device is brought into its closed configuration. In this regard, it is to be appreciated that beverage capsules of this type are a rotationally symmetrical object (at least with regard to its geometry). Hence, the beverage preparation device and/or beverage capsule need to be configured to accommodate the range of possible relative positions.

Further, any surface irregularities in the engagement face 118 (due to manufacturing variations, tolerances, and/or by virtue of the beverage preparation device design requirements) can give rise to liquid leakage.

Typically, these issues are mitigated by demanding relatively small tolerances in the capsule geometries, and imparting design requirements on the capsule.

With respect to the beverage capsule 100, the different densities of the chamber engagement portion 18 and the radially outer portion 20 within the flange 16 facilitates reliable alignment of the beverage capsule 100 with the capsule holder 110 and its mating components. Further, incorporating the chamber engagement portion 18 into the capsule 10 as previously described has the benefit of achieving a suitable and reliable seal to the brewing chamber, whilst also keeping the clamping force at an acceptable level. The beverage preparation device is then able to attain the required pressurisation of the brewing chamber, which leads to reliable infusion of the beverage ingredient, and extraction of the beverage.

It is known that pulp fibre materials can be “tacky” when rewetted. This is at least partly because of the large surface area of loose pulp fibres at the surface of the pulp material and, when wet, the propensity to establish capillary bridges between the pulp fibre material and surfaces of various other materials. The capillary bridging action forms a tackiness (in other words, stickiness) that creates bonds due to the surface tensions (in other words, an attraction) between the wetted pulp fibre material and surface of another material/article; that attraction must be overcome in order to release the pulp fibre material from the other material/article. The establishment of capillary bridges, and the strength of the attractive force between the pulp fibre material and the other surface is dependent on a number of factors, including the proximity of the two surfaces, shape characteristics of the surfaces (such as the smoothness), the materials of the two surfaces, and the liquid characteristics. It will be apparent that there is a reasonable likelihood of the capsule 10 becoming sticky during the beverage preparation process, and so also after the conclusion of the beverage preparation process, when the spent capsule 10 is to be released from the brewing chamber.

A part of the second major surface 34 that is within the chamber engagement portion 18 has greater roughness, relative to the radially outer portion 20 and the annular side wall 22. This greater roughness of the second major surface 34 within the chamber engagement portion 18 is achieved by the process that forms the chamber engagement portion 18 within the flange 16, which are described in Australian Patent Application No. 2022902962. As shown in FIG. 8, the part of the second major surface 34 that is within the chamber engagement portion 18 contacts the engagement face 118 of the capsule holder 110 during the beverage preparation process.

As noted previously, the engagement face 118 of the capsule holder 110 bears against the second major surface 34 of the capsule 10, when the beverage preparation device is in the closed configuration. The Applicant has conducted trials of brewing beverages using sample beverage capsules substantially as described herein to objectively assess the release of the spent beverage capsules from various commercially available beverage preparation devices. The sample beverage capsules 100 having a chamber engagement portion 18, and hence the part of the second major surface 34 that has greater roughness, were observed to release from the capsule holder 110 readily and reliably. In contrast, substantially similar beverage capsules that do not have a chamber engagement portion 18, were observed to have some difficulty in releasing from the capsule holder 110. Without wishing to be bound to any particular theory, it is believed that the beverage capsules 100 with a chamber engagement portion 18, and hence greater roughness in the corresponding part of the second major surface 34, have lower adhesion between the pulp material and the capsule holder 110 due to weaker bonds created by the capillary bridges.

The above described attributes of the second major surface 34 of the flange 16 of the capsule 10 provides the advantage of mitigating adhesion between the second major surface 34 and the capsule holder 110 after beverage preparation is complete. Hence, when the beverage preparation device is returned to the open configuration, the beverage capsule 100 will reliably disengage from the capsule holder 110 for discharge from the device.

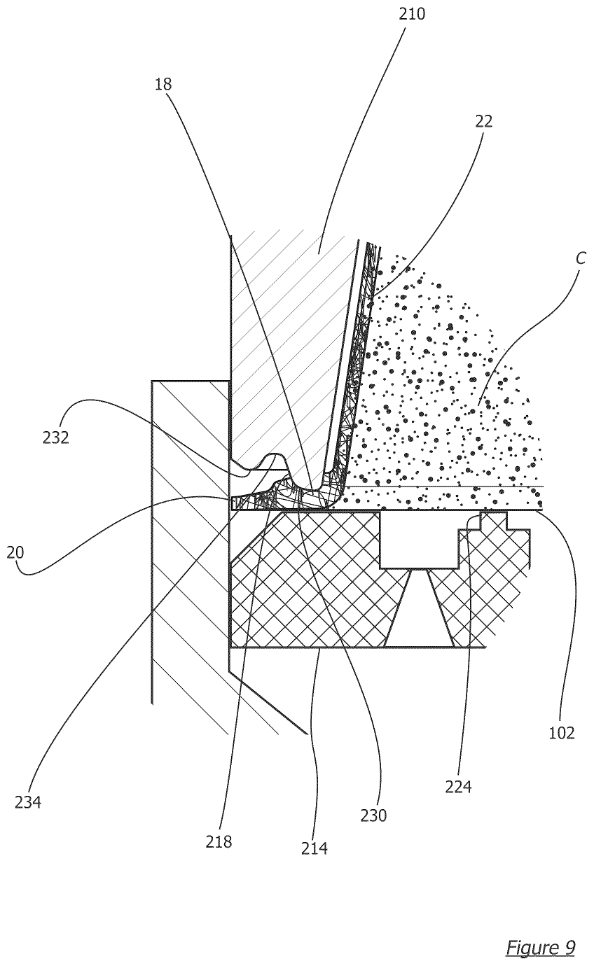

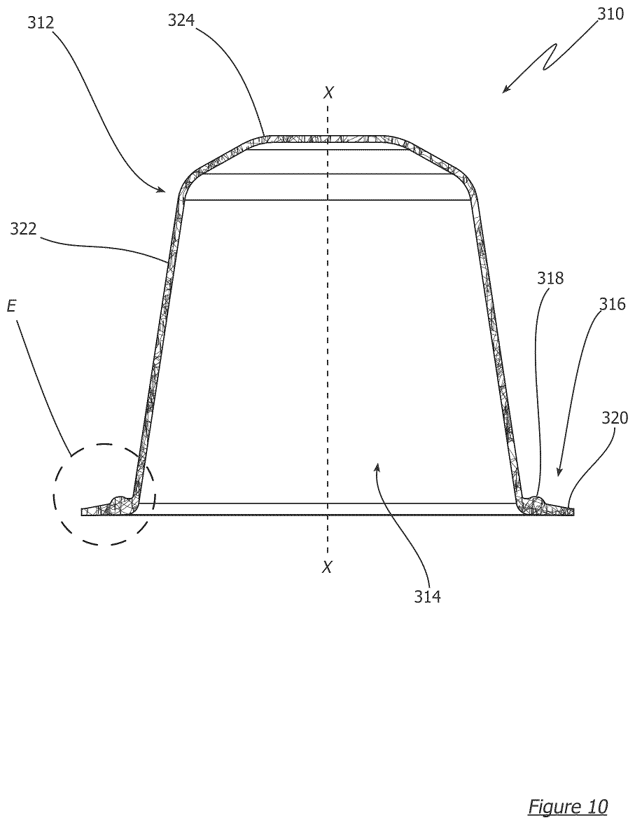

FIG. 9 is an equivalent view of FIG. 8, with component parts of an alternative beverage preparation device. Parts of the alternative beverage preparation device that are the same or similar to parts of the beverage preparation device described in reference to FIGS. 6 to 8 have the same reference numbers with the prefix “2” replacing the prefix “1” and for succinctness, will not be described again.

The alternative beverage preparation device differs in the form of the engagement face 218 of the capsule holder 210. To this end, the engagement face 218 has an inner annular ring 230 and an outer annular ring 232. The two rings 230, 232 are separated by an annular groove 234. FIG. 9 illustrates the clamping and compression of the chamber engagement portion 18 with the inner annular ring 230.

In certain beverage preparation devices, part of the inner annular ring 230 includes a series of circumferentially spaced fillet-like formations. These formations can influence the pressure applied to the flange of a beverage capsule that is captured between the capsule holder 210 and the orifice plate 214.

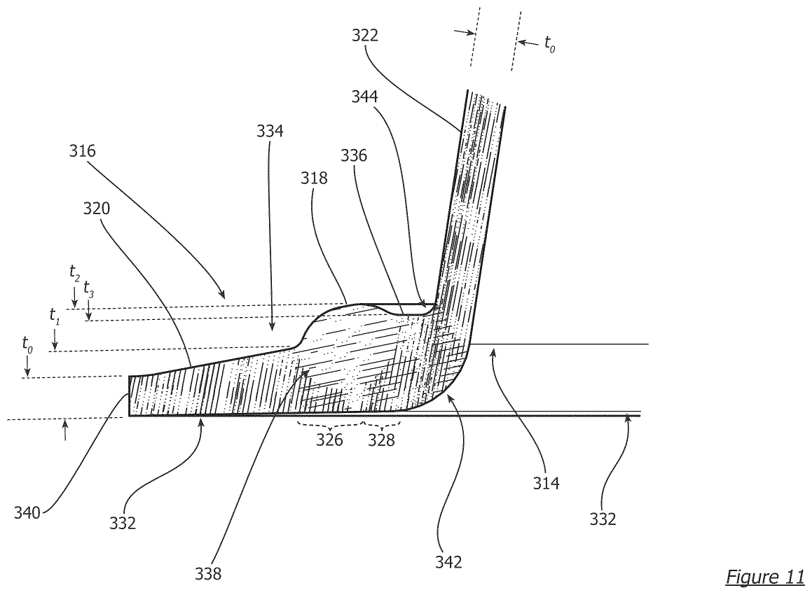

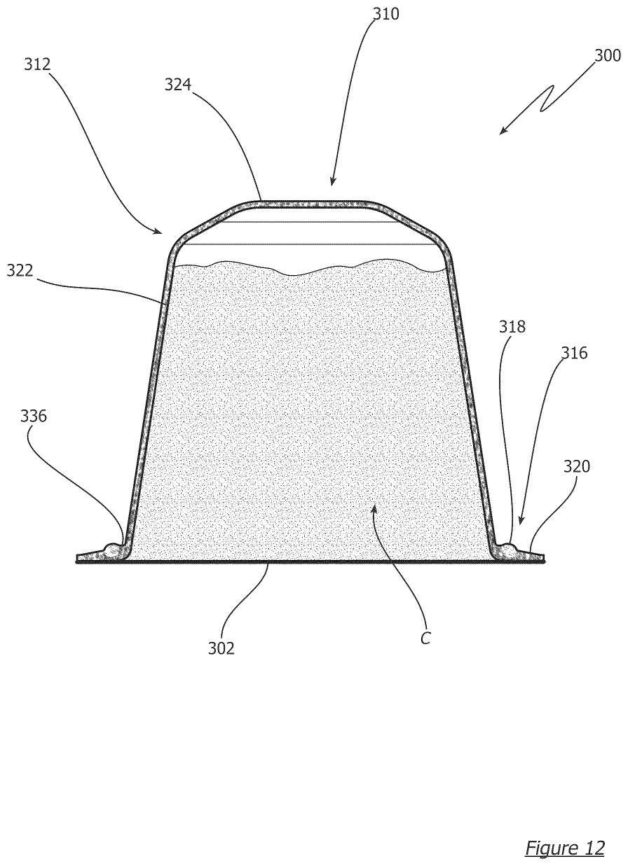

FIGS. 10 and 11 show a capsule 310 according to a further embodiment. Parts of the capsule 310 that are the same or similar to parts of the capsule 10 have the same reference numbers with the prefix “3” and for succinctness, will not be described again.

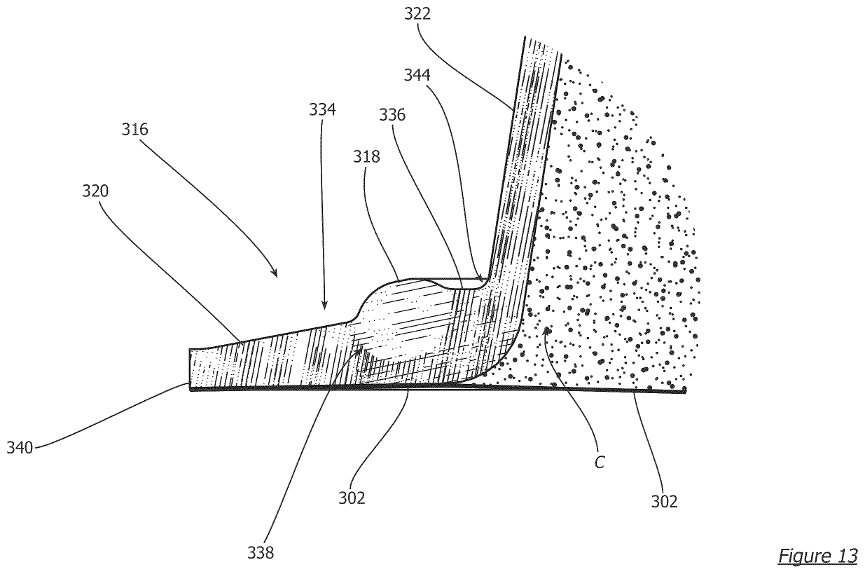

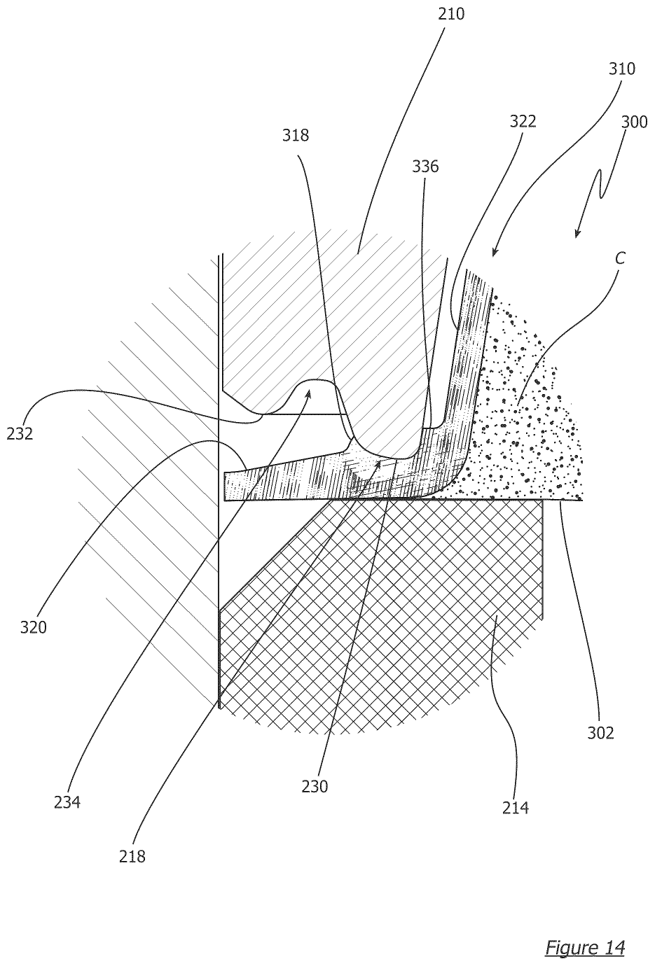

FIGS. 12 and 13 show a beverage capsule 300 that includes the capsule 310 as illustrated in FIG. 11, and a lid 302 that is adhered to the flange 316 of the capsule 310. A dose of a beverage ingredient C is contained within the internal cavity of the beverage capsule 300.

The chamber engagement portion 318 of the flange 316 can be formed using the processes and forming equipment that are described and illustrated in the Applicant's Australian Patent Application No. 2022902962.

The flange 316 of the capsule 310 includes a radially innermost portion 336 that spaces the chamber engagement portion 318 from the body 312. The density of pulp fibre material within the radially innermost portion 336 is greater than the minimum density of the pulp fibre material within the chamber engagement portion 318.

The pulp fibre material within the radially innermost portion 336 of the flange 316 has a density that is approximately equal to that of the annular side wall 322.

In the embodiment illustrated in FIGS. 10 and 11, the second major surface 334 is concave and conical. Further, the second major surface 334 has a cone angle of approximately 1°. The form of the second major surface 334 is useful for certain post-production process considerations, but does not make a significant contribution to material characteristics of the pulp fibre material in the flange 316.

The radially outer portion 320 defines an outer peripheral edge 340 of the flange 316. Within the radially outer portion 320, the material thickness (measured in a direction that is generally orthogonal to the second major surface 334) increases from a minimum thickness to at the outer peripheral edge 340 to a material thickness ty adjacent to the chamber engagement portion 318.

The chamber engagement portion 318 of the flange 316 has a density of the pulp fibre material that is less than the maximum density of the pulp fibre material in the radially outer portion 320.

In this example, the chamber engagement portion 318 has a first part 326, and a second part 328. Within the first part 326, the material thickness of the pulp fibre material increases in the radially inward direction from the first material thickness t₁ to a second material thickness t₂. Within the second part 328, the material thickness of the pulp fibre material decreases in the radially inward direction from the second material thickness t₂ to a third material thickness t₃.

As shown in FIG. 11, the first material thickness t₁ is less than the second material thickness t₂, and the second material thickness t₂ is greater than the third material thickness t₃.

The above described transitions between material thicknesses are not linear with respect to radial distance from the longitudinal axis X.

As shown in FIG. 11, part of the radially innermost portion 336 of the flange 316 is adjacent to the second part 328. The thickness of this part of the radially innermost portion 336 corresponds with the third material thickness t₃.

The shape of the first major surface 332 and the external surface of the annular side wall 322 is such that an annular trough is formed between the chamber engagement portion 318 and annular side wall 322. The base of the annular trough corresponds with the radially innermost portion 336.

The capsule 310 is formed of pulp fibre material, and the body 312 and the flange 316 are formed contiguously in a pulp moulding process. In other words, the body 312 and flange 316 are formed as a unitary item.

In the transition from the flange 316 into the annular side wall 322 of the body 312, a first chamfer 342 is formed in the transition from the second major surface 334 to the internal surface of the annular side wall 322 (having regard to the internal cavity 314). Similarly, a second chamfer 344 is formed in the transition from the first major surface 332 to the external surface of the annular side wall 322.

In the embodiment illustrated in FIGS. 10 and 11, the pulp fibre material of the capsule 310 that is between the first and second chamfers 342, 344 has a density that is approximately equal to that of the annular side wall 322.

The above described densities of pulp fibre material in the capsule 310 are determined by several factors. These include the accumulation of pulp fibre slurry in the initial stages of forming the capsule 310, and also the compression of that accumulated pulp fibre during subsequent stages of forming the capsule 310. With respect to the latter factor, the extent of compression is determined by shape of the mould tools, and the process conditions in the various pressing operations that are performed after the initial of accumulation of the pulp fibre slurry, from a suspension of pulp fibre in liquid. In this regard, reference may again be made to the processes and forming equipment that are described and illustrated in the Applicant's Australian Patent Application No. 2023901521.

With reference to FIGS. 12 and 13, it may be observed that the beverage ingredient C contained within the internal cavity 314 of the beverage capsule 100 is separated from the atmosphere that surrounds the beverage capsule 300. To this end, the capsule 310 and the lid 302 provide barriers to transmission/exchange of various gases between the atmosphere and the internal cavity 314.

Coating materials can be applied to the body and/or the flange to enhance the capacity of the capsule to act as a barrier to atmospheric gas(es). The capsule 310 can have one or more barrier materials that are supported on a surface of the body 310 and provide a resistance and/or a barrier to transmission of one or both of oxygen gas and water vapour. By way of example, barrier materials can be provided to the surfaces of the body 312 that face inwardly towards the internal cavity 314. In other words, barrier materials can be provided as coatings to the surfaces of the pulp fibre material of the annular side wall 322 and the base 324. Examples of barrier materials are described in Australian Patent Application No. 2023901526 (filed in the name of the Applicant on 17 May 2023), the disclosure of which is incorporated herein by reference.

Notwithstanding that barrier materials may be provided to one or multiple surfaces of the capsule 310, the compressed pulp fibre material provides a degree of resistance and/or barrier to transmission of atmospheric gases. The barrier that is provided by the capsule 310 is the combination of the barriers provided by the pulp fibre material, and the barrier materials. Further, the efficacy of the pulp fibre material as a barrier to atmospheric gases is related to the density of the pulp fibre material, and to the degree of compression of that pulp fibre material.

As noted above, the density of the pulp fibre material within the radially innermost portion 336 and the annular side wall 322 is approximately equal. This provides the benefit that the barrier properties of the parts of the capsule 310 that surround the internal cavity 314 are approximately equal. Further, with appropriate selection of material(s), the lid 302 provides a barrier to transmission of atmospheric gases that is at least equal to that of the capsule 310 itself.

It will be observed from FIGS. 11 and 13 that the lid 302 is attached to the first major surface 332 up to the transition from the flange 316 to the annular side wall 322. By virtue of the shape and configuration of the capsule 310, the “pathways” for atmospheric gases to access the beverage ingredient C contained within the internal cavity 314 by the capsule 310 and lid 302 are: through the annular side wall 322, through the lid 302, or through the flange 316. Including the radially innermost portion 336 within the flange 316 has the advantage of mitigating transfer of atmospheric gases that may penetrate the pulp fibre material of the chamber engagement portion 318 towards the internal cavity 314.

It will be apparent from this description that the density of the pulp fibre material within the chamber engagement portion 318 is less than that of the radially innermost portion 336 and the annular side wall 322. Spacing the chamber engagement portion 318 from the body 312 by the radially innermost portion 336 aids in separating the lower density pulp fibre material within the chamber engagement portion 318 from the internal cavity 314.

FIG. 14 is an enlarged schematic view showing part of the beverage capsule 300 of FIGS. 12 and 13. FIG. 14 also shows the component parts of the beverage preparation device that are illustrated in FIG. 9.

Those familiar with beverage preparation devices of the type with which beverage capsule 300 is to be used will appreciate that many of these devices have the brewing chamber generally horizontal, such that the orifice plate 214 is generally vertical. In this arrangement, when the beverage capsule 300 is within the brewing chamber, the longitudinal axis X of the capsule 310 is horizontal. The parts of the beverage capsule 300 in the region of the flange 316 are annular. A consequence of these geometries is that the alignment of the beverage capsule 300 within the brewing chamber is not precise. Hence, the engagement face 218 of the capsule holder 210, and the flange 316 may not be concentric. Frequently the beverage capsule 300 locates in the capsule holder 210 such that a lowermost region of the annular side wall 322 is in contact with the capsule holder 210, and a diametrically opposed uppermost region of the annular side wall 322 is spaced from the capsule holder 210.

The tendency of pulp fibre material in the capsule 310 to swell in contact with water (including during the beverage preparation process) is inversely related to the density of the pulp fibre material. For instance, the pulp fibre material within chamber engagement portion 318 has lower density compared with the radially innermost portion 336. In particular, the innermost portion 336 has a maximum density of pulp fibre material that is greater than the minimum density of the pulp fibre material in the chamber engagement portion 318. Incorporating the radially innermost portion 336 between the chamber engagement portion 318 and the annular side wall 322 provides an annular portion of pulp fibre material that is within the flange 316 and is adjacent the annular side wall 322, and which has lower tendency to swell during the beverage preparation process. A benefit of this arrangement is that swelling of pulp fibre material during the beverage preparation process is less likely to result in the beverage capsule 300 jamming in the capsule holder 210 after brewing.

Similarly with the arrangements illustrated in FIGS. 8 and 9, including the chamber engagement portion 318 provides the benefit of facilitating that part of the flange 316 to conform to the shape of the engagement face 118, 218 of the capsule holder 110, 210, as the beverage preparation device is brought into the closed configuration around the beverage capsule 300.

### Examples

The Applicant formed capsules of bagasse pulp fibre materials substantially as described in reference to FIGS. 1 to 5, and 10 and 11.

Surface roughness:

Surface roughness measurements were taken of the first major surface 332 within each of the chamber engagement portion 318 and radially outer portion 320 of the flange 316.

The measurements were made using an optical profilometer (which for these tests was a non-contact laser microscope type roughness measuring instrument). The zoom of the profilometer was set to 50×. For each measurement, the size of the area measured was 260 μm×260 μm. The surface measured is cylindrical in form, and a transformation was applied to remove the effect of the cylindrical form.

At each measurement, the arithmetic mean roughness (Sa), and maximum height (Sz) were recorded. Arithmetic mean roughness (Sa) is absolute value of the difference in height of each point on the surface, compared to the arithmetical mean of that surface (within the measurement area). Maximum height is the sum of the largest peak height value and the largest pit depth value (within the measurement area).

Table 1 documents the above described surface roughness parameters for each of the two capsules measured. In Table 1:
“Area 1” is within the radially outer portion 320,
“Area 2” is within the chamber engagement portion 318, and
“Side wall” is an external part of the annular side wall 322.

TABLE 1

| Capsule | Weight (g) | Area | Sa (μm) | Sz (μm) |
|---|---|---|---|---|
| Capsule 1 | 1.008 | Area 1 | 2.563 | 31.370 |
| | | Area 2 | 8.857 | 98.22 |
| | | Side wall | 7.199 | 165.222 |
| Capsule 2 | 0.893 | Area 1 | 2.96 | 28.07 |
| | | Area 2 | 5.224 | 85.591 |
| | | Side wall | 6.819 | 206.923 |

The above results indicate an arithmetic mean roughness (Sa) within the chamber engagement portion 318 that is of the order of 175% to 350% of that within the radially outer portion 320. In other words, a ratio of the order of 1.75:1 to 3.5:1.

In addition, the maximum height (Sz) within the chamber engagement portion 318 that is of the order of 305% to 315% of that within the radially outer portion 320. In other words, a ratio of approximately 3:1.

It may be observed from Table 1 that these surface roughness parameters have a connection with the weight of the capsule. This is understood to be a consequence of the press tool characteristics (including the minimum tool separation during pressing, and the press closing force), and the amount of pulp slurry that is accumulated on the tool in the initial forming stage.

Preliminary observations of Capsules 1 and 2 indicate the density of the pulp fibre material within the chamber engagement portion 318 is not uniform in a direction generally parallel with the longitudinal axis X. In particular, a region (indicated in FIGS. 11 and 13 by arrow 338) of the chamber engagement portion 318 that is intermediate the first and second major surfaces 332, 334 has a change in the density of the pulp fibre material. To this end and within the chamber engagement portion 318, the pulp fibre material adjacent to the first major surface 332 has a higher density compared to the pulp fibre material adjacent to the second major surface 334. It is understood that this characteristic is a consequence of the tools and processes that form the chamber engagement portion 318.

It is noteworthy that the engagement face of the capsule holder in certain brewing devices may not be fully rotationally symmetrical, concentric, and/or parallel with the orifice plate, such that the contact pressure of the capsule holder on the flange of the beverage capsule is uneven. This can be exacerbated in some brewing devices that have an engagement face with a series of circumferentially spaced fillet-like formations.

Trials of example beverage capsules indicate that the rougher pulp fibre structure in the part of the second major surface 334 can more readily conform to the engagement face of the capsule holder. This readiness to conform may also be improved with a degree of swelling of the pulp fibre material within the chamber engagement portion 318 that can occur during the beverage preparation process. In this regard, the lower density pulp fibre material in the chamber engagement portion 318, compared with other parts of the flange 316, allows for increased swelling in the chamber engagement portion 318.

Table 2 documents the thicknesses of parts of the flange 316 (as referenced in FIG. 11 and the accompanying description) in the two sample capsules, and of the annular side wall 322.

TABLE 2

| Position | Thickness (mm) |
|---|---|
| Flange at t₀ | 0.500 |
| Flange at t₁ | 0.870 |
| Flange at t₂ | 1.400 |
| Flange at t₃ | 1.210 |
| Side wall | 0.331 |

Density at different parts of the capsules can be calculated on the basis of the measured capsule body weight, and measured thicknesses, and capsule body external surface area. Table 3 documents the calculated densities for each of the sample capsules, based on the material thicknesses that are documented in Table 2.

TABLE 3

Density (kg/m3)

| Position | Capsule 1 | Capsule 2 |
|---|---|---|
| Flange at t₀ | 736 | 652 |
| Flange at t₁ | 423 | 375 |
| Flange at t₂ | 263 | 233 |
| Flange at t₃ | 304 | 269 |
| Side wall | 1,110 | 985 |

It may be observed from Table 3 that for both sample capsules:
1. the density of the pulp fibre material in the chamber engagement portion (corresponding with the Flange at t₂) is less than the maximum density of the pulp fibre material in the body (that is, within the annular side wall);
2. the density of the pulp fibre material within the chamber engagement portion (corresponding with the Flange at t₂) is less than the maximum density of the pulp fibre material in the radially outer portion (corresponding with the Flange at to); and
3. the density of the pulp fibre material within the radially innermost portion (corresponding with the Flange at t₃) is:
   a is greater than that of the pulp fibre material within the chamber engagement portion (corresponding with the Flange at t₂), and
   b. less than that of the pulp fibre material within the annular side wall.

Other sample capsules of like form to those in FIGS. 1 and 10 have been formed, filled with a quantity of roasted and ground coffee, and closed with a suitable lid material to make beverage capsules as described herein.

By way of non-limiting examples, a potentially suitable material for use as the lid with the capsule body 10 in a capsule 2 is Sylvicta® brand food-contact paper, produced for Arjowiggins Group Ltd/Fedrigoni S.p.A., which is reported to have high barrier properties. Another potentially suitable material for use as the lid with the capsule body 10 in a capsule 2 is a multi-layer material that is disclosed in International Patent Publication No. WO 2022/053339 A1, in the name of Société Des Produits Nestlé S.A. (in which the multi-layer material is described as a “delivery wall” of a beverage capsule).

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-29. (canceled)

30. A capsule for use in preparing a beverage in a beverage preparation device that has a brewing chamber, the capsule comprising:
a body having a cup shape that defines an internal cavity within which to contain a beverage ingredient; and
a flange that extends radially outwardly from a mouth of the body, the flange including a chamber engagement portion that, during preparation of a beverage, is to be in engagement with components of the beverage preparation device that define the brewing chamber,
wherein the body and the flange are formed of compressed pulp fibre material, and
wherein at least the chamber engagement portion of the flange has a density of the pulp fibre material that is less than the maximum density of the pulp fibre material in the body.

31. The capsule of claim 30, wherein the flange has a radially outer portion that surrounds the chamber engagement portion,
wherein the density of the pulp fibre material within the chamber engagement portion is less than the maximum density of the pulp fibre material in the radially outer portion.

32. The capsule of claim 30, wherein the flange includes a radially innermost portion that spaces the chamber engagement portion from the body,
wherein the innermost portion has a density of pulp fibre material that is greater than the minimum density of the pulp fibre material in the chamber engagement portion.

33. The capsule of claim 30, wherein the pulp fibre density within the flange is approximately inversely proportional to the material thickness.

34. The capsule of claim 30, wherein the chamber engagement portion is an annular part of the flange.

35. The capsule of claim 34, wherein the flange has a first major surface that faces away from the body and provides a contact surface against which a lid is to be adhered,
wherein the material thickness of the chamber engagement portion is greater than the material thickness of the radially outer portion.

36. The capsule of claim 30, wherein the chamber engagement portion is be arranged with:
a first part, in which the density of the pulp fibre material transitions from a first density to a second density, and
a second part, in which the density of the pulp fibre material is substantially constant and equal to the second density,
wherein the first density is greater than the second density.

37. The capsule of claim 36, wherein the first part of the chamber engagement portion is between the radially outer portion of the flange, and the second part of the chamber engagement portion.

38. The capsule of claim 36, wherein the chamber engagement portion is further arranged with a third part in which the density of the pulp fibre material increases in a radially inward direction.

39. The capsule of claim 38, wherein the third part of the chamber engagement portion is between the second part and the body.

40. The capsule of claim 30, wherein the flange has a second major surface that faces in the direction of the body,
wherein the part of the second major surface that is within the chamber engagement portion is more rough compared to:
the external surface of the body, and/or
the part of the second major surface that is within the radially outer portion.

41. A beverage capsule for use with a beverage preparation device to prepare a beverage, the beverage capsule comprising:
a capsule of claim 30;
a lid that is adhered to the flange of the capsule to close and seal the internal cavity; and
a dose of beverage ingredients contained within the internal cavity.

42. The capsule of claim 30, wherein the flange comprises a first major surface that faces away from the body and provides a contact surface against which a lid is to be adhered, and a second major surface that faces in the direction of the body, and
wherein the part of the second major surface that is within the chamber engagement portion is more rough compared to:
the external surface of the body, and/or
the part of the second major surface that is within the radially outer portion.

43. The capsule of claim 30, wherein the greater roughness of the part of the second major surface that is within the chamber engagement portion is a result of that part of the second major surface being unconstrained during a pulp fibre pressing stage in the pulp moulding process by which the capsule is formed.

44. The capsule of claim 30, wherein the chamber engagement portion is arranged with:
a first part, in which the material thickness of the pulp fibre material transitions from a first material thickness to a second material thickness, and
a second part, in which the material thickness of the pulp fibre material transitions from the second material thickness to a third material thickness,
wherein the first material thickness is less than the second material thickness, and the second material thickness is less than the third material thickness.

45. The capsule of claim 44, wherein the first part of the chamber engagement portion is between the radially outer portion of the flange, and the second part of the chamber engagement portion.

46. The capsule of claim 44, wherein the chamber engagement portion is further arranged with a third part in which the material thickness of the pulp fibre material is substantially constant.

47. The capsule of claim 30, wherein the third part of the chamber engagement portion is between the second part and the body.
